(19) United States
(12) Patent Application Publication
(10) Pub. No.: US 2024/0389005 A1
(43) Pub. Date: Nov. 21, 2024

(54) METHOD, SYSTEM, AND NON-TRANSITORY COMPUTER-READABLE RECORDING MEDIUM FOR SUPPORTING WIRELESS INTERWORKING OF DEVICES

(71) Applicant: HUINNO, CO., LTD., Seoul (KR)

(72) Inventors: Joo Min KIM, Seoul (KR); Wan Seo CHA, Seoul (KR)

(21) Appl. No.: 18/785,188

(22) Filed: Jul. 26, 2024

Related U.S. Application Data
(63) Continuation of application No. PCT/KR2023/001134, filed on Jan. 25, 2023.

(30) Foreign Application Priority Data
Jan. 26, 2022 (KR) 10-2022-0011371

(51) Int. Cl. H04W 48/16; H04W 48/08

(52) U.S. Cl. CPC H04W 48/16; H04W 48/08

(57) ABSTRACT

A method for supporting wireless interworking of devices includes causing a packet containing trigger information to be transmitted in an advertising mode, in response to occurrence of an event for wireless interworking; and causing a connection mode to be activated on the basis of a result of verifying the trigger information, and causing a packet containing information associated with the event to be transmitted in the connection mode.

### CROSS-REFERENCE TO RELATED APPLICATIONS

This application is a Continuation of International Application No. PCT/KR2023/001134 filed Jan. 25, 2023, which claims priority from Korean Application No. 10-2022-0011371 filed Jan. 26, 2022. The aforementioned applications are incorporated herein by reference in their entireties.

### TECHNICAL FIELD

The present invention relates to a method, system, and non-transitory computer-readable recording medium for supporting wireless interworking of devices.

### RELATED ART

Due to recent rapid progress in science and technology, the quality of life of all mankind is being enhanced and medical environment has changed a great deal. Particularly, in recent years, wearable monitoring devices for remotely monitoring biosignal data have become widely available to the public.

Such wearable monitoring devices may be used to monitor the health status of patients in a medical institution such as a hospital. To this end, it is required to deploy, throughout the medical institution, gateways for relaying communication between the wearable monitoring devices and a remote monitoring system in the hospital.

The gateways deployed in the medical institution as above are typically limited in the number of wearable monitoring devices that can be connected to one gateway. In the past, the stability of connections between the wearable monitoring devices and the gateways has been ensured by expanding a large number of gateways in advance in preparation for the increase in the number of wearable monitoring devices. However, this approach has the problem of inefficient use of wireless resources.

### SUMMARY

One object of the present invention is to solve all the above-described problems in the prior art.

Another object of the invention is to ensure that connections between wearable monitoring devices and gateways are intermittently maintained in a communication network where a Bluetooth Low Energy (BLE) communication scheme is implemented, thereby maximizing the number of wearable monitoring devices that can be connected to one gateway, and maximizing the efficiency of installing gateways in a medical institution.

The representative configurations of the invention to achieve the above objects are described below.

According to one aspect of the invention, there is provided a method for supporting wireless interworking of devices, comprising the steps of: causing a packet containing trigger information to be transmitted in an advertising mode, in response to occurrence of an event for wireless interworking; and causing a connection mode to be activated on the basis of a result of verifying the trigger information, and causing a packet containing information associated with the event to be transmitted in the connection mode.

According to another aspect of the invention, there is provided a system for supporting wireless interworking of devices, comprising: an advertising mode management unit configured to cause a packet containing trigger information to be transmitted in an advertising mode, in response to occurrence of an event for wireless interworking; and a connection mode management unit configured to cause a connection mode to be activated on the basis of a result of verifying the trigger information, and cause a packet containing information associated with the event to be transmitted in the connection mode.

In addition, there are further provided other methods and systems to implement the invention, as well as non-transitory computer-readable recording media having stored thereon computer programs for executing the methods.

According to the invention, it is possible to ensure that connections between wearable monitoring devices and gateways are intermittently maintained in a communication network where Bluetooth Low Energy (BLE) communication scheme is implemented, thereby maximizing the number of wearable monitoring devices that can be connected to one gateway, and maximizing the efficiency of installing gateways in a medical institution.

### BRIEF DESCRIPTION OF THE DRAWINGS

FIG. 1 schematically shows the configuration of an entire system for supporting wireless interworking of devices according to one embodiment of the invention.

FIG. 2 specifically shows the internal configuration of a support system according to one embodiment of the invention.

FIG. 3 illustratively shows the results of wireless interworking according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the invention will be described in detail with reference to the accompanying drawings to enable those skilled in the art to easily implement the invention.

### Configuration of the Entire System

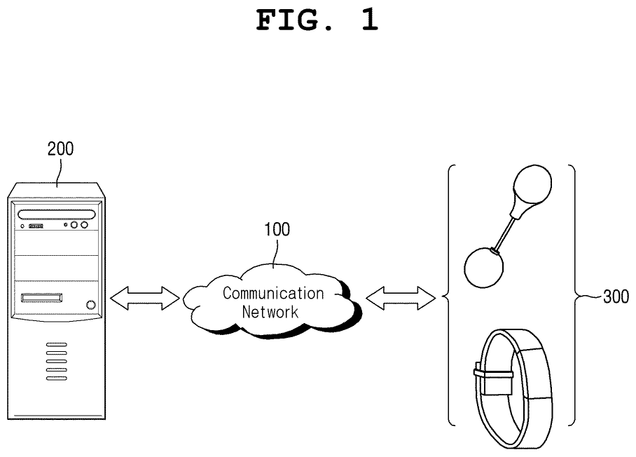

FIG. 1 schematically shows the configuration of the entire system for supporting wireless interworking of devices according to one embodiment of the invention.

As shown in FIG. 1, the entire system according to one embodiment of the invention may comprise a communication network 100, a support system 200, and a device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs).

Preferably, the communication network 100 described herein may be a personal area network (PAN), at least a part of which may be implemented with a communication scheme such as Bluetooth communication (more specifically, Bluetooth Low Energy (BLE) communication), ANT+, and Zigbee.

However, the communication network 100 is not necessarily limited thereto, and may at least partially include known wired/wireless data communication networks, known telephone networks, or known wired/wireless television communication networks. For example, the communication network 100 may be a wireless data communication network, at least a part of which may be implemented with a conventional communication scheme such as radio frequency (RF) communication, WiFi communication, cellular communication (e.g., Long Term Evolution (LTE)), infrared communication, and ultrasonic communication.

Next, the support system 200 according to one embodiment of the invention may communicate with the device 300 to be described below via the communication network 100, and may function to: cause a packet containing trigger information to be transmitted in an advertising mode, in response to occurrence of an event for wireless interworking; and cause a connection mode to be activated on the basis of a result of verifying the trigger information, and cause a packet containing information associated with the event to be transmitted in the connection mode. Meanwhile, the support system 200 may be digital equipment having a memory means and a microprocessor for computing capabilities, and may be, for example, a server system operating on the communication network 100.

The configuration and functions of the support system 200 according to one embodiment of the invention will be discussed in detail below.

Next, the device 300 according to one embodiment of the invention is digital equipment capable of connecting to and then communicating with the support system 200, and having a memory means and a microprocessor for computing capabilities, such as a smart patch, a smart watch, a smart band, and smart glasses, and may be a wearable monitoring device including a sensing means (e.g., a contact electrode or an imaging apparatus) for measuring a biosignal (e.g., an electrocardiogram (ECG), an electromyogram (EMG), an electroencephalogram (EEG), or a photoplethysmogram (PPG)) from a human body, and a display means for providing a user with a variety of information on the measurement of the biosignal.

Meanwhile, the device 300 according to one embodiment of the invention may include an application (not shown) for assisting a user to be provided with the functions associated with wireless interworking support according to the invention from the support system 200. The application may be downloaded from the support system 200 or an external application distribution server (not shown). Meanwhile, the characteristics of the application may be generally similar to those of an advertising mode management unit 210, a connection mode management unit 220, a communication unit 230, and a control unit 240 of the support system 200 to be described below. Here, at least a part of the application may be replaced with a hardware device or a firmware device that may perform a substantially equal or equivalent function, as necessary.

### Configuration of the Support System

Hereinafter, the internal configuration of the support system 200 crucial for implementing the invention and the functions of the respective components thereof will be discussed.

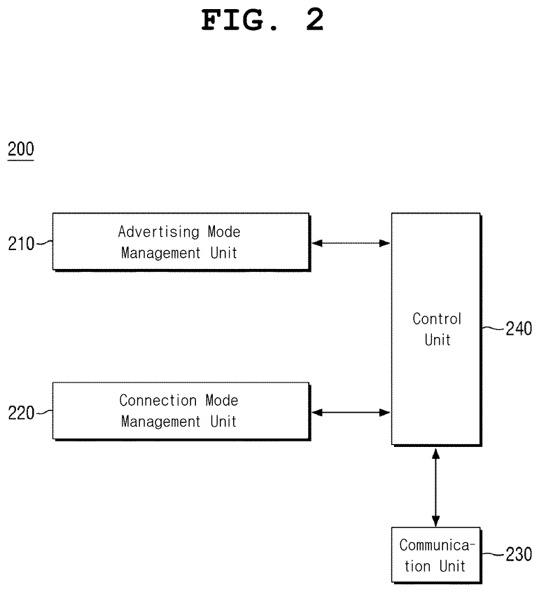

FIG. 2 specifically shows the internal configuration of the support system 200 according to one embodiment of the invention.

As shown in FIG. 2, the support system 200 according to one embodiment of the invention may comprise an advertising mode management unit 210, a connection mode management unit 220, a communication unit 230, and a control unit 240. According to one embodiment of the invention, at least some of the advertising mode management unit 210, the connection mode management unit 220, the communication unit 230, and the control unit 240 of the support system 200 may be program modules to communicate with an external system (not shown). The program modules may be included in the support system 200 in the form of operating systems, application program modules, or other program modules, while they may be physically stored in a variety of commonly known storage devices. Further, the program modules may also be stored in a remote storage device that may communicate with the support system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the support system 200 has been described as above, and it will be apparent to those skilled in the art that at least a part of the components or functions of the support system 200 may be implemented in the device 300 or a server (not shown) or included in an external system (not shown), as necessary.

First, the advertising mode management unit 210 according to one embodiment of the invention may function to cause a packet containing trigger information to be transmitted in an advertising mode, in response to occurrence of an event for wireless interworking.

Here, the event for wireless interworking according to one embodiment of the invention may refer to an event requiring transmission of predetermined information from the device 300 to a gateway (not shown) or a remote monitoring system (not shown) to be described below. According to one embodiment of the invention, the event for wireless interworking may include, but is not limited to, an event regarding abnormal biosignal data being acquired from a subject by the device 300 (or a sensing means of the device 300), and may be diversely changed as long as the objects of the invention may be achieved.

The advertising mode management unit 210 according to one embodiment of the invention may assist the device 300 to wirelessly interwork (or connect) with the gateway in response to the occurrence of the event for wireless interworking. Specifically, the advertising mode management unit 210 according to one embodiment of the invention may assist the device 300 and the gateway to interwork with each other via the communication network 100 in which a Bluetooth Low Energy (BLE) communication scheme is implemented. Meanwhile, the gateway according to one embodiment of the invention may be provided in a medical institution (e.g., a hospital or health center) and may function to relay communication between the device 300 worn by a subject (or patient) visiting the medical institution and the remote monitoring system provided in the medical institution (wherein the remote monitoring system may be a system for analyzing or detecting abnormality in the subject's health status by remotely monitoring information acquired from the subject by the device 300).

More specifically, the advertising mode management unit 210 according to one embodiment of the invention may cause the device 300 (or a BLE module (not shown) included in the device 300) to transmit a packet containing trigger information in a BLE advertising mode, in response to the occurrence of the event for wireless interworking. Here, according to one embodiment of the invention, the packet may be an advertising packet or a scan response packet. Further, according to one embodiment of the invention, the trigger information may include first information indicating the occurrence of the event for wireless interworking, and second information on an attribute of the event for wireless interworking (e.g., a type of the event for wireless interworking). According to one embodiment of the invention, the packet containing the trigger information may be transmitted from the device 300 to the gateway, and the gateway receiving the packet may verify the trigger information contained in the packet (e.g., verify the validity or integrity of each of the first information and the second information).

For example, in response to the occurrence of the event for wireless interworking, the advertising mode management unit 210 according to one embodiment of the invention may cause an advertising packet to contain trigger information and cause the advertising packet to be transmitted from the device 300. Next, the gateway according to one embodiment of the invention may receive the advertising packet transmitted from the device 300 and verify the trigger information contained in the advertising packet.

As another example, the advertising mode management unit 210 according to one embodiment of the invention may cause an advertising packet to be transmitted from the device 300. Next, the gateway according to one embodiment of the invention may receive the advertising packet transmitted from the device 300 and transmit a scan request packet corresponding to the advertising packet to the device 300. Next, in response to the occurrence of the event for wireless interworking, the advertising mode management unit 210 according to one embodiment of the invention may cause a scan response packet corresponding to the scan request packet to contain trigger information and cause the scan response packet to be transmitted from the device 300. Next, the gateway according to one embodiment of the invention may receive the scan response packet transmitted from the device 300 and verify the trigger information contained in the scan response packet.

Next, the connection mode management unit 220 according to one embodiment of the invention may function to causing a connection mode to be activated on the basis of a result of verifying the trigger information, and causing a packet containing information associated with the event for wireless interworking to be transmitted in the connection mode.

Specifically, the connection mode management unit 220 according to one embodiment of the invention may cause a BLE connection mode to be activated when the trigger information has been verified (wherein the verification of the trigger information may be performed by the gateway as described above). Further, the connection mode management unit 220 according to one embodiment of the invention may cause the device 300 (or the BLE module included in the device 300) to transmit a packet containing information associated with the event for wireless interworking in the connection mode activated as above. Here, according to one embodiment of the invention, the information associated with the event for wireless interworking may refer to predetermined information that is required to be transmitted to the above-described gateway or remote monitoring system. For example, when the event for wireless interworking is assumed to be an electrocardiogram with an abnormal waveform (e.g., tachycardia or bradycardia) being acquired from the subject by the device 300 (or the sensing means of the device 300), the information associated with the event for wireless interworking may be information in which the electrocardiogram is recorded.

For example, it is assumed that the trigger information contained in the advertising packet or scan response packet has been verified. The gateway according to one embodiment of the invention may transmit a connection request packet to the device 300 on the basis of the result of verifying the trigger information. Next, the connection mode management unit 220 according to one embodiment of the invention may cause connection request acknowledgment information (or a packet containing the information) corresponding to the connection request packet to be transmitted from the device 300. According to one embodiment of the invention, the connection between the device 300 and the gateway may be completed through the above process, so that the connection mode management unit 220 according to one embodiment of the invention may cause the connection mode to be activated. Next, the connection mode management unit 220 according to one embodiment of the invention may cause the device 300 to transmit a packet containing information associated with the event for wireless interworking to the gateway in the connection mode activated as above. Next, the connection mode management unit 220 according to one embodiment of the invention may cause the device 300 and the gateway to be disconnected when the transmission of the packet containing the information associated with the event for wireless interworking is completed.

According to one embodiment of the invention, the above-described functions of the advertising mode management unit 210 and the connection mode management unit 220 may cause the connection mode to be maintained (or the connection to be maintained) intermittently between the device 300 and the gateway only when the event for wireless interworking occurs. Thus, according to one embodiment of the invention, it is possible to maximize the number of devices 300 that can be connected to one gateway, and maximize the efficiency of installing gateways in a medical institution.

Meanwhile, according to one embodiment of the invention, while it is important for the connection mode to be intermittently maintained in the device 300 as described above, it may be important in some cases for the connection mode to be constantly maintained in the device 300. For example, when the connection mode is constantly maintained in the device 300, it is possible to continuously monitor the subject's health status while allowing for rapid response in the event of an emergency. To this end, according to one embodiment of the invention, the device 300 may be implemented such that a default value is set to cause the connection mode to be intermittently maintained in the device 300, while the default value is changeable in some cases to cause the connection mode to be constantly maintained in the device 300. According to one embodiment of the invention, the device 300 in which the connection mode is constantly maintained may be determined by the subject wearing the device 300 or the remote monitoring system. Meanwhile, according to one embodiment of the invention, in the device 300 in which the connection mode is constantly maintained, the connection mode may be activated on the basis of a common BLE communication scheme (specifically, according to the common BLE communication scheme, the aforementioned trigger information is not contained in an advertising packet or a scan response packet), rather than the functions of the advertising mode management unit 210 and the connection mode management unit 220.

Meanwhile, the connection mode management unit 220 according to one embodiment of the invention may determine the number of gateways to be operated (or the number of gateways needed) with reference to the devices 300 in which the connection mode is constantly maintained and the devices 300 in which the connection mode is intermittently maintained.

Specifically, the connection mode management unit 220 according to one embodiment of the invention may increase the number of gateways to be operated in response to the number of devices 300 in which the connection mode is constantly maintained exceeding at least one threshold value. Here, according to one embodiment of the invention, the at least one threshold value may be a multiple of the maximum number of devices 300 that can be connected to one gateway. For example, when the maximum number of devices 300 that can be connected to one gateway is assumed to be 10, the at least one threshold value may be a multiple of 10 (i.e., 10, 20, 30, 40, or the like). In this regard, the connection mode management unit 220 according to one embodiment of the invention may determine the number of gateways to be operated (NoG_ah1) according to Equation 1 below. Here, according to one embodiment of the invention, a may be the number of devices 300 in which the connection mode is constantly maintained, and N may be the maximum number of devices 300 that can be connected to one gateway.

$$NoG\_ah 1 = int ( ( a - 1 ) / N ) + 1 \qquad ( EQ . 1 )$$

Meanwhile, the connection mode management unit 220 according to one embodiment of the invention may determine the number of gateways to be operated on the basis of traffic caused by the devices 300 in which the connection mode is intermittently maintained, in addition to the number of devices 300 in which the connection mode is constantly maintained. Specifically, regardless of the absolute number of devices 300 in which the connection mode is intermittently maintained, the connection mode management unit 220 according to one embodiment of the invention may determine the number of gateways to be operated solely on the basis of traffic caused by the devices 300 (e.g., traffic generated according to the frequency with which the connection mode is maintained). More specifically, the connection mode management unit 220 according to one embodiment of the invention may determine the number of gateways to be operated by adding the number obtained from Equation 1 above and the number of gateways required on the basis of traffic caused by the devices 300 in which the connection mode is intermittently maintained.

That is, the connection mode management unit 220 according to one embodiment of the invention may finally determine the number of gateways to be operated (NoG_ah2) according to Equation 2 below. Here, according to one embodiment of the invention, a may be the number of devices 300 in which the connection mode is constantly maintained, N may be the maximum number of devices 300 that can be connected to one gateway, and b may be the number of gateways required on the basis of traffic caused by the devices 300 in which the connection mode is intermittently maintained.

$$NoG\_ah 2 = int ( ( a - 1 ) / N ) + 1 + b \qquad ( EQ . 2 )$$

Next, the communication unit 230 according to one embodiment of the invention may function to enable data transmission/reception from/to the advertising mode management unit 210 and the connection mode management unit 220.

Lastly, the control unit 240 according to one embodiment of the invention may function to control data flow among of the advertising mode management unit 210, the connection mode management unit 220, and the communication unit 230. That is, the control unit 240 according to the invention may control data flow into/out of the support system 200 or data flow among the respective components of the support system 200, such that the advertising mode management unit 210, the connection mode management unit 220, and the communication unit 230 may carry out their particular functions, respectively.

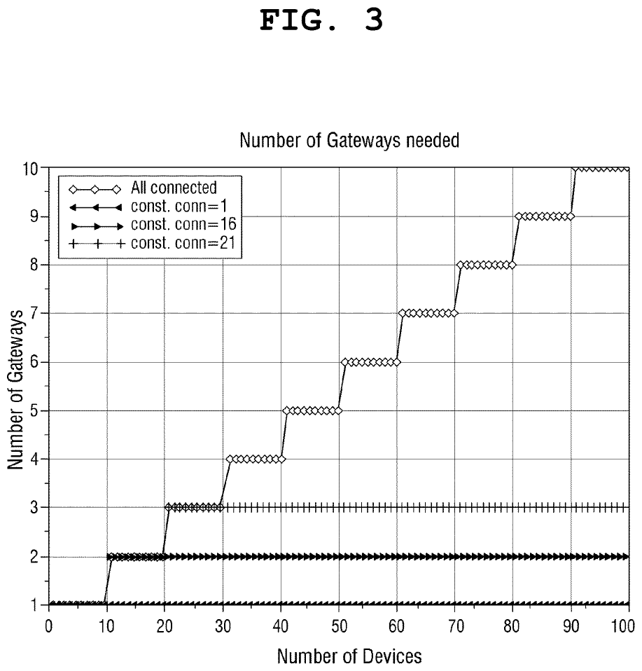

FIG. 3 illustratively shows the results of wireless interworking according to one embodiment of the invention.

Referring to FIG. 3, with respect to “All connected”, the number of gateways to be operated is shown when all the devices 300 are the devices 300 in which the connection mode is constantly maintained, the maximum number of devices 300 that can be connected to one gateway is 10, and the number of gateways required on the basis of traffic caused by the devices 300 in which the connection mode is intermittently maintained is zero.

Further, with respect to “const. conn”, the number of gateways to be operated is shown when the number of devices 300 in which the connection mode is constantly maintained is 1, 16, or 21, the maximum number of devices 300 that can be connected to one gateway is 10, and the number of gateways required on the basis of traffic caused by the devices 300 in which the connection mode is intermittently maintained is zero. Here, according to one embodiment of the invention, it can be seen that with respect to “const. conn”, the number of gateways to be operated does not increase even if the absolute number of devices 300 in which the connection mode is intermittently maintained increases.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for supporting wireless interworking of devices, comprising the steps of:
(a) causing a packet containing trigger information to be transmitted in an advertising mode, in response to occurrence of an event for wireless interworking; and
(b) causing a connection mode to be activated on the basis of a result of verifying the trigger information, and causing a packet containing information associated with the event to be transmitted in the connection mode.

2. The method of claim 1, wherein the packet containing the trigger information is an advertising packet or a scan response packet.

3. The method of claim 1, wherein in step (b), a number of gateways to be operated is determined with reference to devices in which the connection mode is constantly maintained and devices in which the connection mode is intermittently maintained.

4. The method of claim 3, wherein in step (b), the number of gateways to be operated is increased in response to a number of devices in which the connection mode is constantly maintained exceeding at least one threshold value.

5. The method of claim 3, wherein in step (b), the number of gateways to be operated is determined on the basis of traffic caused by the devices in which the connection mode is intermittently maintained.

6. A non-transitory computer-readable recording medium having stored thereon a computer program for executing the method of claim 1.

7. A system for supporting wireless interworking of devices, comprising:
an advertising mode management unit configured to cause a packet containing trigger information to be transmitted in an advertising mode, in response to occurrence of an event for wireless interworking; and
a connection mode management unit configured to cause a connection mode to be activated on the basis of a result of verifying the trigger information, and cause a packet containing information associated with the event to be transmitted in the connection mode.

8. The system of claim 7, wherein the packet containing the trigger information is an advertising packet or a scan response packet.

9. The system of claim 7, wherein the connection mode management unit is configured to determine a number of gateways to be operated with reference to devices in which the connection mode is constantly maintained and devices in which the connection mode is intermittently maintained.

10. The system of claim 9, wherein the connection mode management unit is configured to increase the number of gateways to be operated in response to a number of devices in which the connection mode is constantly maintained exceeding at least one threshold value.

11. The system of claim 9, wherein the connection mode management unit is configured to determine the number of gateways to be operated on the basis of traffic caused by the devices in which the connection mode is intermittently maintained.
